(19) United States
(12) Patent Application Publication
(10) Pub. No.: US 2019/0286746 A1
(43) Pub. Date: Sep. 19, 2019

(54) Search Engine Quality Evaluation Via Replaying Search Queries

(71) Applicant: Microsoft Technology Licensing, LLC, Redmond, WA (US)

(72) Inventors: Lei Li, Sunnyvale, CA (US); Huiji Gao, Sunnyvale, CA (US)

(21) Appl. No.: 15/920,856

(22) Filed: Mar. 14, 2018

(51) Int. Cl. G06F 17/30

(52) U.S. Cl. CPC G06F 17/30864; G06N 99/005; G06F 17/30457; G06F 17/3053

(57) ABSTRACT

In an example embodiment, traditional offline analysis of search engine quality is modified to provide multiple replays of queries against new versions of search engine algorithms. This helps to evaluate quality of new versions of search engine algorithms while reducing or eliminating parity issues without increasing network bandwidth utilization.

### TECHNICAL FIELD

The present disclosure generally relates to technical problems encountered in evaluating search engine quality. More specifically, the present disclosure relates to the replaying of search queries to improve search engine quality evaluation.

### BACKGROUND

Online social network services provide users with a mechanism for defining, and memorializing in a digital format, their relationships with other people and other entities (e g., companies, schools, etc.) This digital representation of real-world relationships and associations is frequently referred to as a social graph. There are a variety of web-based applications and services that implement and maintain their own social graphs, and still more applications and/or services that leverage the social graph of a third-party social network service (e.g., via publically available application programming interfaces, or APIs). The number and variety of applications and services that leverage a social graph maintained by a social network service is seemingly endless. For instance, a variety of messaging and content sharing applications leverage a social graph to establish user privileges for sharing content with, or accessing the content of, others.

In addition to maintaining a social graph, many social network services maintain a variety of personal information about their members. For instance, with many social network services, when a user registers to become a member and/or at various times subsequent to registering, the member is prompted to provide a variety of personal or biographical information, which may be displayed in a member's personal web page. Such information is commonly referred to as personal profile information, or simply “profile information,” and when shown collectively, it is commonly referred to as a member's profile. For instance, with some of the many social network services in use today, the personal information that is commonly requested and displayed as part of a member's profile includes a person's age, birthdate, gender, interests, contact information, residential address, home town and/or state, the name of the person's spouse and/or family members, and so forth. With certain social network services, such as some business or professional network services, a member's personal information may include information commonly included in a professional resume or curriculum vitae, such as information about a person's education, the schools, colleges or universities that the member attended, the company at which a person is employed, an industry in which a person is employed, a job title or function, an employment history, skills possessed by a person, professional organizations of which a person is a member, and so on.

Because social network services are a rich source of information about people and their relationships with other people, social network services are an extremely useful tool for performing certain tasks. For example, just as a telephone directory, phone book, or white pages previously served as the go-to source for basic information about people, contemporary social network services serve as a far richer directory of people. Many people use social network services to search for member profiles of friends, colleagues, classmates, and other people they may know, or want to know. Accordingly, many social network services provide a search engine to facilitate searching for the member profiles of members of the social network service.

The social network search engine evaluates a plurality of features of member profiles against a search ranking algorithm, which assigns a score to each member profile based on relevance to a search query input to the search engine. Each feature may be, for example, a field of the member profile (e.g., location) or a result of a calculation performed on one or more fields of the member profile (e.g., a counting of total number of first degree connections from the member profile).

In more technologically complex social networking service environments, the ranking of search results is determined by the combination of ranking models and ranking features, which can be serialized to model files used for scoring. The search quality of searches is of prime importance to social networking services.

When a search ranking algorithm is updated, it may add in additional features that it evaluates when calculating the score for a member profile. From the technological standpoint, however, it is a non-trivial task to evaluate the impact of such new features on the search quality. Currently, an engineer must implement the feature via user-defined functions, train the models offline, and calculate offline metrics. If the model performs better than the existing production model in offline comparison, the feature implementation may be converted to usable code (e.g., Java code) and then deployed to the production model. The relevance metrics are then re-evaluated online. The entire process is very time consuming and cost-intensive. Additionally, the code parity, as well as the context parity when the vertical index is being used, cannot he ensured with offline training and online scoring, and hence in some circumstances the evaluation for both the offline and online experiments is inconsistent.

It is challenging to address these problems in social networking service search engines due to the complicated search ecosystems of these search engines This is because the search queries and ranking features are heavily dependent on a search index. Offline analysis without the involvement of the search index may introduce a lot of inconsistency when it is being hooked up with an online environment. Furthermore, offline analysis using large amounts of testing data requires large amounts of feature dumps, where, for example, search results and features of the search results are downloaded to an offline store for analysis. This can use significant amounts of network bandwidth and slow network access.

### BRIEF DESCRIPTION OF THE DRAWINGS

Some embodiments of the technology are illustrated, by way of example and not limitation, in the figures of the accompanying drawings.

FIG. 1 is a block diagram illustrating a client-server system, in accordance with an example embodiment.

FIG. 2 is a block diagram showing the functional components of a social networking service, including a data processing module referred to herein as a search engine, for use in generating and providing search results for a search query, consistent with some embodiments of the present disclosure.

FIG. 3 is a block diagram illustrating a search engine algorithm quality testing system, in accordance with an example embodiment.

FIG. 4 is a block diagram illustrating an offline analysis component in more detail, in accordance with an example embodiment.

FIG. 5 is a flow diagram illustrating a method of altering a search ranking algorithm, in accordance with an example embodiment.

FIG. 6 is a block diagram illustrating a software architecture, in accordance with an example embodiment.

FIG. 7 illustrates a diagrammatic representation of a machine in the form of a computer system within which a set of instructions may be executed for causing the machine to perform any one or more of the methodologies discussed herein, according to an example embodiment

### DETAILED DESCRIPTION

### Overview

The present disclosure describes, among other things, methods, systems, and computer program products that individually provide various functionality In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In an example embodiment, traditional offline analysis of search engine quality is modified to provide multiple replays of queries against new versions of search engine algorithms. This helps to evaluate quality of new versions of search engine algorithms while reducing or eliminating parity issues without increasing network bandwidth utilization.

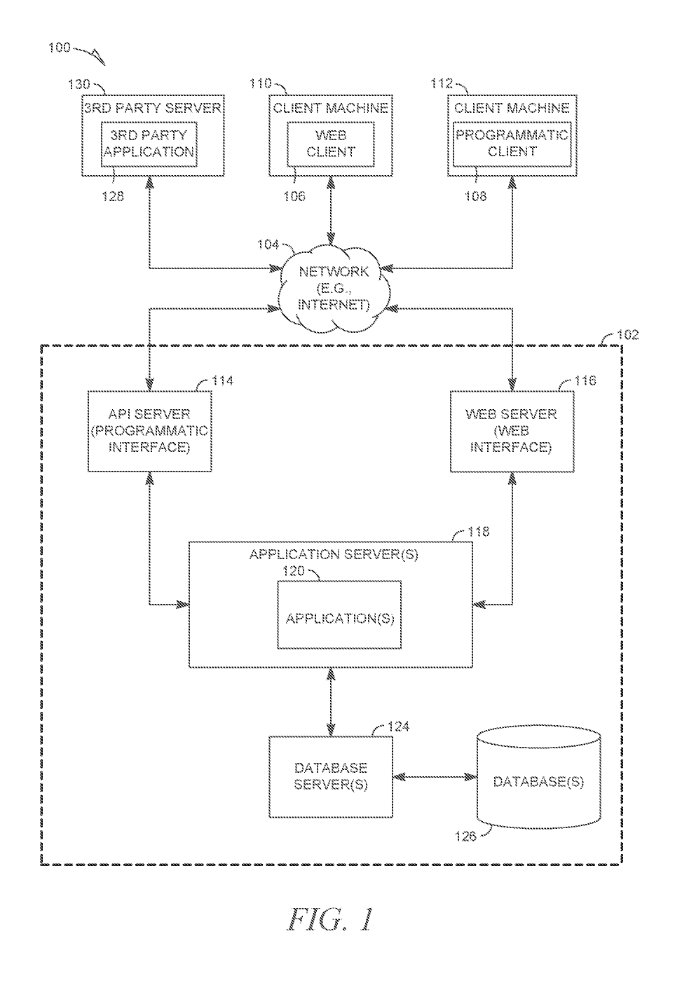

FIG. 1 is a block diagram illustrating a client-server system 100, in accordance with an example embodiment. A networked system 102 provides server-side functionality via a network 104 (e.g., the Internet or a wide area network (WAN)) to one or more clients. FIG. 1 illustrates, for example, a web client 106 (e.g., a browser) and a programmatic client 108 executing on respective client machines 110 and 112.

An application programming interface (API) server 114 and a web server 116 are coupled to, and provide programmatic and web interfaces respectively to, one or more application servers 118. The application server(s) 118 host one or more applications 120. The application servers) 118 are, in turn, shown to be coupled to one or more database servers 124 that facilitate access to one or more databases 126. While the application(s) 120 are shown in FIG. 1 to form part of the networked system 102, it will be appreciated that, in alternative embodiments, the applications) 120 may form part of a service that is separate and distinct from the networked system 102.

Further, while the client-server system 100 shown in FIG. 1 employs a client-server architecture, the present disclosure is, of course, not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the application(s) 120 via the programmatic interface provided by the API server 114

FIG. 1 also illustrates a third-party application 128, executing on a third-party server 130, as having programmatic access to the networked system 102 via the programmatic interface provided by the API server 114. For example, the third-party application 128 may, utilizing information retrieved from the networked system 102, support one or more features or functions on a website hosted by a third party. The third-party website may, for example, provide one or more functions that are supported by the relevant applications 120 of the networked system 102.

In some embodiments, any website referred to herein may comprise online content that may be rendered on a variety of devices including, but not limited to, a desktop personal computer (PC), a laptop, and a mobile device (e.g., a tablet computer, smartphone, etc.). In this respect, any of these devices may be employed by a user to use the features of the present disclosure In some embodiments, a user can use a mobile app on a mobile device (any of the client machines 110, 112 and the third-party server 130 may be a mobile device) to access and browse online content, such as any of the online content disclosed herein. A mobile server (e.g., the API server 114) may communicate with the mobile app and the application server(s) 118 in order to make the features of the present disclosure available on the mobile device.

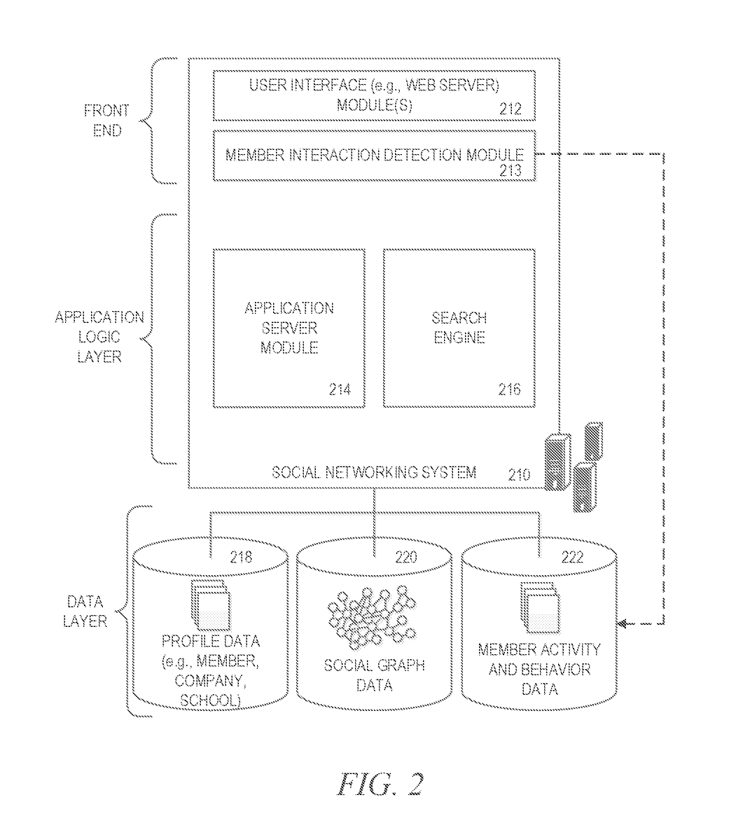

In some embodiments, the networked system 102 may comprise functional components of a social networking service. FIG. 2 is a block diagram showing the functional components of a social networking system 210 consistent with some embodiments of the present disclosure. In some embodiments, a search engine 216 may reside on the application server(s) 118 shown in FIG. 1. However. it is contemplated that other configurations are also within the scope of the present disclosure.

As shown in FIG. 2, a front end may comprise a user interface module (e.g., a web server 116) 212, which receives requests from various client computing devices, and communicates appropriate responses to the requesting client devices. For example, the user interface modulets) 212 may receive requests in the form of Hypertext Transfer Protocol (HTTP) requests or other web-based API requests. In addition, a member interaction detection module 213 may be provided to detect various interactions that members have with different applications 120, services, and content presented. As shown in FIG. 2, upon detecting a particular interaction, the member interaction detection module 213 logs the interaction, including the type of interaction and any metadata relating to the interaction, in a member activity and behavior database 222.

An application logic layer may include one or more various application server modules 214, which, in conjunction with the user interface module(s) 212, generate various user interfaces (e.g., web pages) with data retrieved from various data sources in a data layer. In some embodiments, individual application server modules 214 are used to implement the functionality associated with various applications 120 and/or services provided by the social networking service.

As shown in FIG. 2, the data layer may include several databases 126, such as a profile database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 218. Similarly, when a representative of an organization initially registers the organization with the social networking service, the representative may be prompted to provide certain information about the organization. This information may be stored, for example, in the profile database 218 or another database (not shown). In some embodiments, the profile data may be processed (e.g., in the background or offline) to generate various derived profile data, for example, if a member has provided information about various job titles that the member has held with the same organization or different organizations, and for how long, this information can be used to infer or derive a member profile attribute indicating the member's overall seniority level, or seniority level within a particular organization. In some embodiments, importing or otherwise accessing data from one or more externally hosted data sources may enrich profile data for both members and organizations. For instance, with organizations in particular, financial data may be imported from one or more external data sources and made part of an organization's profile.

Once registered, a member may invite other members, or be invited by other members, to connect via the social networking service. A “connection” may constitute a bilateral agreement by the members, such that both members acknowledge the establishment of the connection. Similarly, in some embodiments, a member may elect to “follow” another member In contrast to establishing a connection, “following” another member typically is a unilateral operation and, at least in some embodiments, does not require acknowledgement or approval by the member who is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream In any case, the various associations and relationships that the members establish with other members, or with other entities and objects, are stored and maintained within a social graph in a social graph database 220.

As members interact with the various applications 120, services, and content made available via the social networking service, the members' interactions and behavior (e.g., content viewed, links or buttons selected, messages responded to, etc.) may be tracked, and information concerning the members' activities and behavior may be logged or stored, for example, as indicated in FIG. 2, by the member activity and behavior database 222. This logged activity information may then be used by the search engine 216 to determine search results for a search query.

In some embodiments, the databases 218, 220, and 222 may be incorporated into the database(s) 126 in FIG. 1. However, other configurations are also within the scope of the present disclosure.

Although not shown, in some embodiments, the social networking system 210 provides an API module via which applications 120 and services can access various data and services provided or maintained by the social networking service. For example, using an API, an application 120 may be able to request and/or receive one or more navigation recommendations. Such applications 120 may be browser-based applications 120, or may be operating system-specific. In particular, some applications 120 may reside and execute (at least partially) on one or more mobile devices (e.g., phone or tablet computing devices) with a mobile operating system. Furthermore, while in many cases the applications 120 or services that leverage the API may be applications 120 and services that are developed and maintained by the entity operating the social networking service, nothing other than data privacy concerns prevents the API from being provided to the public or to certain third parties under special arrangements, thereby making the navigation recommendations available to third-party applications 128 and services.

Although the search engine 216 is referred to herein as being used in the context of a social networking service, it is contemplated that it may also be employed in the context of any website or online services. Additionally, although features of the present disclosure are referred to herein as being used or presented in the context of a web page, it is contemplated that any user interlace view (e.g., a user interface on a mobile device or on desktop software) is within the scope of the present disclosure.

In an example embodiment, when member profiles are indexed, forward search indexes are created and stored. The search engine 216 facilitates the indexing of and searching for content within the social networking service, such as the indexing of and searching for data or information contained in the data layer, such as profile data (stored, e.g., in the profile database 218), social graph data (stored, e.g., in the social graph database 220), and/or member activity and behavior data (stored, e g, in the member activity and behavior database 222). The search engine 216 may collect, parse, and/or store data in an index or other similar structure to facilitate the identification and retrieval of information in response to received queries for information. This may include, but is not limited to, forward search indexes, inverted indexes, N-gram indexes, and so forth.

When processing a search query, a search engine may compare keywords included in a search query to keywords in a search index corresponding to documents in a corpus. Thus, in various embodiments, by using a search index, a search engine may not need to scan every document in the corpus to find documents matching a search query. Instead the search engine merely identifies documents satisfying a search query by comparing the search query to the search index. In various embodiments, the benefits of faster retrieval of search results must be weighed against the costs of maintaining the search index, including extra storage space, processing power, and so on. Additionally, in various embodiments, the benefits must be weighed against any loss of usefulness or accuracy that may result from the search query being compared with a subset of the documents (e.g., the search index) instead of the documents themselves.

An example of a search index is an inverted index. An inverted index includes (e.g., a list of words and a list of documents in the corpus that contain each of the words (e.g., stored in a hash table, distributed hash table, binary tree, or other data structure). In various embodiments, the index may include information pertaining to a frequency of each word n each document (e.g., to enable the search engine to rank documents satisfying the query) or the positions of each word in each document (e.g., to enable the search engine to support phrase searching).

Another example of a search index is a forward index. A forward index may include a list of documents in the corpus and a list of words corresponding to each document in the corpus (e.g., stored in a hash table, distributed hash table, binary tree, or other data structure). When a new document is added to the corpus, it may be immediately added to the forward index. Later (e.g., during asynchronous system processing), the forward index may be converted into an inverted index. Thus, the use of the forward index may prevent any bottleneck that may result from documents having to be immediately converted to an inverted index.

Notably, the search engine 216 is located on the social networking system 210. For purposes of this disclosure, this means that the search engine 216 operates on a server operated by the social networking system 210 for purposes of search query fulfilment.

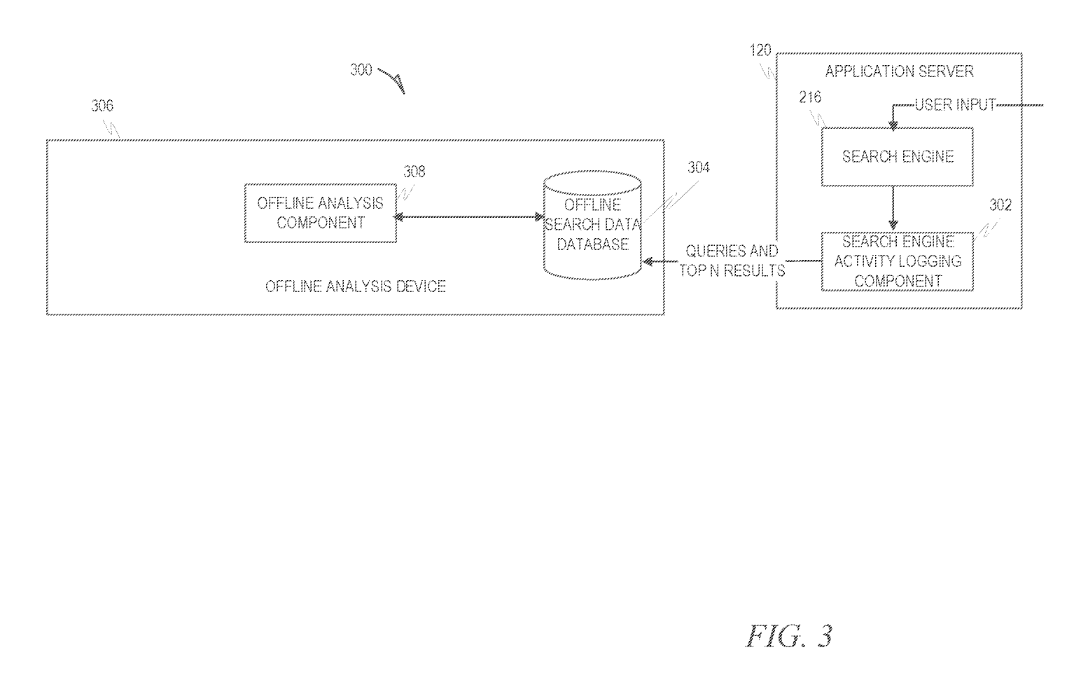

Evaluation of the search engine algorithm quality, however, may be performed on a separate device. FIG. 3 is a block diagram illustrating a search engine algorithm quality testing system 300, in accordance with an example embodiment. Notably, a search engine activity logging component 302 located on the social networking system 210 tracks search queries and the top n search results presented in response to the queries, and downloads this information to an offline search data database 304 located on an offline analysis device 306. This offline analysis device 306 may be a server or a client, but is located across a network from where the search engine 216 is deployed. Due to network bandwidth issues involved in tracking and downloading the search data, n is typically limited to a relatively low number, such as 10. Thus, while the user may be able to view any number of search results in response to a search query, the offline search data database 304 will only obtain the top n search results for analysis. As described earlier, this can create a parity problem in that the offline analysis performed by an offline analysis component 308 to test a new version of a search ranking algorithm to be deployed in the search engine 216 will be using a different set of data for testing than is available if the same testing were performed online.

As such, in an example embodiment, the offline analysis component 308 is modified to provide multiple replays of queries against new versions of search engine algorithms to reduce or eliminate parity issues without increasing network bandwidth utilization.

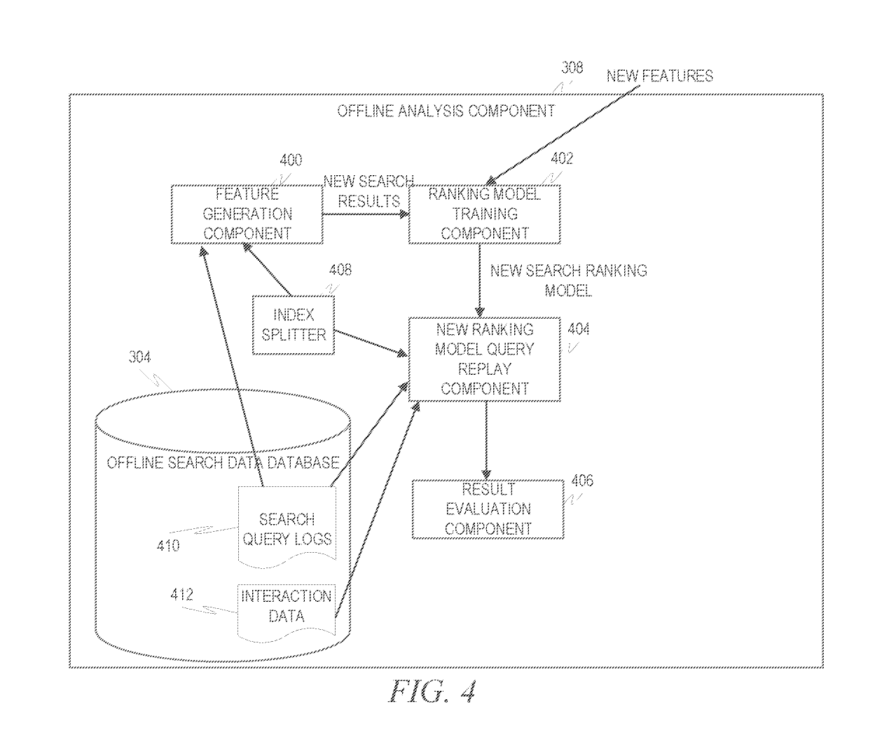

FIG. 4 is a block diagram illustrating an offline analysis component 308 in more detail, in accordance with an example embodiment. The offline analysis component 308 contains a feature generation component 400, a ranking model training component 402, a new ranking model query replay component 404, a result evaluation component 406, and an index splitter 408. The feature generation component 400 extracts search query legs 410 (the record of the search queries) from the offline search data database 304 and replays these search queries against the original search engine ranking model. The feature generation component 400 aims to regenerate the ranking features that were used previously by scoring when the original search requests were issued by the end users, utilizing corresponding search indexes output by the index splitter 408, which will be described in more detail below. The output of this replay is a set of new search results

The feature generation component 400 then joins these new search results with interaction data 412 extracted from the offline search data database 304. This interaction data 412 may include, for example, records of users clicking on particular search results. While click-throughs are a common measure of interest/interactivity between users and search results, other measures may be used in conjunction with or in lieu of click-through, such as other online activities such as forwarding or sharing the search result, dwelling on the search result, favoriting or “liking” the search result, etc. Thus, the joining operation takes each of the new search results and assigns it the interaction data 412 associated with the search result from the online executions of the search engine ranking algorithm, essentially regenerating the features of the original search results.

The ranking model training component 402 takes as input the new search results with the regenerated features, and any additional experimental features that an engineer or other search algorithm modification expert may wish to experiment with, and performs new model training on top of the data. The output includes a new search engine ranking model that includes the experimental features for scoring. This new search engine ranking model can be trained using any search engine ranking strategy, such as linear models or tree models.

The new model query replay component 404 then replaces the existing search engine ranking model in the search query logs 410 with the new trained search engine ranking model and performs a replay on the search logs to obtain new search results, using the search indexes output by the index splitter 408.

The result evaluation component 406 evaluates the new search results that are obtained by replaying the search queries with the new model. The evaluation calculates a list of metrics that can demonstrate the relative quality improvement/degradation of the new search engine ranking model. Examples of such metrics include normalized discounted cumulative gain (NDCG) and click-through-rate at position k (CTR@k) Notably, the result evaluation component 406 may utilize interaction data obtained as part of the search.

The index splitter 408 provides the search index that can be used by the replay framework. This could either be the original search index, or an index with more fine-grained shards in order to accelerate the execution time of the replay.

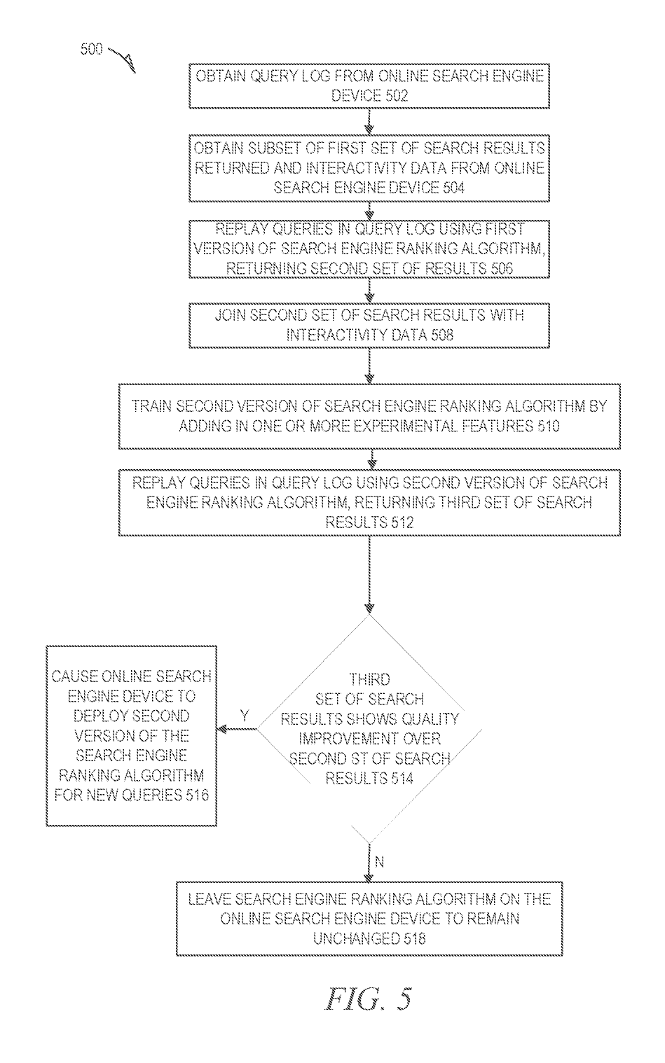

FIG. 5 is a flow diagram illustrating a method 500 of altering a search ranking algorithm, in accordance with an example embodiment. At operation 502, an offline analysis device (e.g., the offline analysis device 306) obtains a query log from an online search engine device (e.g., the search engine 216), the query log comprising a set of queries performed on a first database by a first version of a search engine ranking algorithm. At operation 504, the offline analysis device obtains a subset of a first set of search results returned at the online search engine device in response to the set of queries and interactivity data pertaining to interactions, via a graphical user interface, between users and results in the subset of the first set of search results.

At operation 506, queries in the query log are replayed, on a second database, using the first version of the search engine ranking algorithm, returns a second set of search results. At operation 508, the second set of search results is joined with the interactivity data obtained from the online search engine device.

At operation 510, a second version of the search engine ranking algorithm is trained by adding in one or more experimental features to the first version of the search engine ranking algorithm and training weights for features of the second version of the search engine ranking algorithm using this joined second set of search results and interactivity data obtained from the online search engine device.

At operation 512, queries in the query log are replayed on the second database, using a second version of the search engine ranking algorithm, returning a third set of search results. At operation 514, the third set of search results is evaluated against the second set of search results to determine if the second version of the search engine ranking algorithm demonstrates quality improvement over the first version of the search engine ranking algorithm. If so, then at operation 516, the online search engine device is caused to deploy the second version of the search engine ranking algorithm for new queries on the first database. If not, then at operation 518 the search ranking algorithm deployed on the online search engine device is left unchanged.

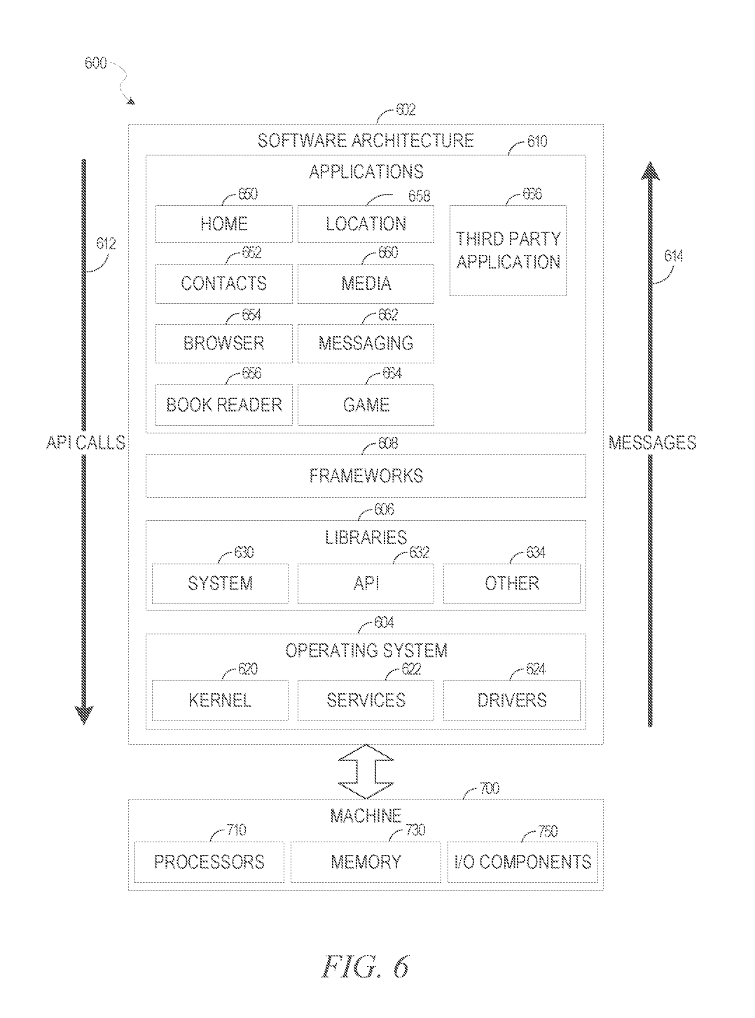

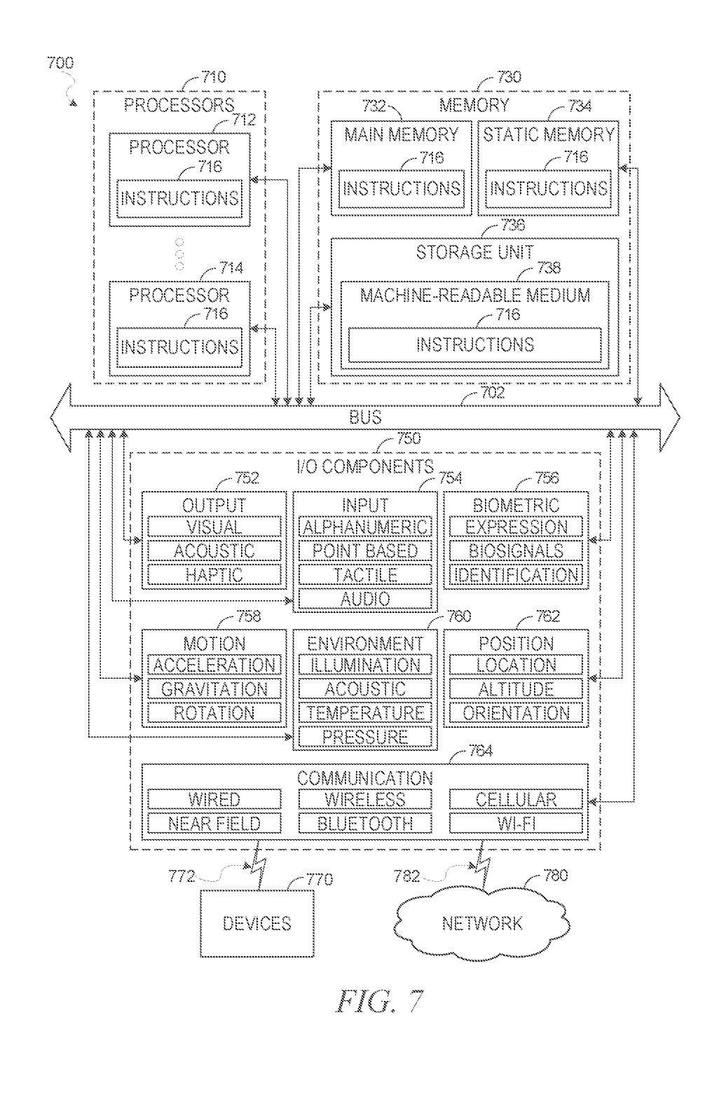

FIG. 6 is a block diagram 600 illustrating a software architecture 602, which can be installed on any one or more of the devices described above. FIG. 6 is merely a non-limiting example of a software architecture, and it will be appreciated that many other architectures can be implemented to facilitate the functionality described herein. In various embodiments, the software architecture 602 is implemented by hardware such as a machine 700 of FIG. 7 that includes processors 710, memory 730, and input;output (I/O) components 750. In this example architecture, the software architecture 602 can be conceptualized as a stack of layers where each layer may provide a particular functionality. For example, the software architecture 602 includes layers such as an operating system 604, libraries 606, frameworks 608, and applications 610. Operationally, the applications 610 invoke API calls 612 through the software stack and receive messages 614 in response to the API calls 612, consistent with some embodiments.

In various implementations, the operating system 604 manages hardware resources and provides common services. The operating system 604 includes, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionality. The services 622 can provide other common services for the other software layers. The drivers 624 are responsible for controlling or interfacing with the underlying hardware, according to some embodiments. For instance, the drivers 624 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610, according to some embodiments. For example, the frameworks 60S provide various GUI functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications, such as a third-party application 666. According to some embodiments, the applications 610 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 612 provided by the operating system 604 to facilitate functionality described herein.

FIG. 7 illustrates a diagrammatic representation of a machine 700 in the form of a computer system within which a set of instructions may be executed for causing the machine to perform any one or more of the methodologies discussed herein, according to an example embodiment. Specifically, FIG. 7 shows a diagrammatic representation of the machine 700 in the example form of a computer system, within which instructions 716 (e.g., software, a program, an application 610, an applet, an app, or other executable code) for causing the machine 700 to perform any one or more of the methodologies discussed herein may be executed. For example, the instructions 716 may cause the machine 700 to execute the method 500 of FIG. 5. Additionally, or alternatively, the instructions 716 may implement FIGS. 1-6, and so forth. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment The machine 700 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions 716 contemporaneously. Although FIG. 7 shows multiple processors 710, the machine 700 may include a single processor with a single core, a single processor with multiple cores (e.g., a multi-core processor), multiple processors with a single core, multiple processors with multiple cores, or any combination thereof.

The memory 730 may include a main memory 732, a static memory 734, and a storage unit 736, all accessible to the processors 710 such as via the bus 702. The main memory 732, the static memory 734, and the storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine 700 will depend on the type of machine 700. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In various example embodiments, the I/O components 750 may include output components 752 and input components 754. The output components 752 may include visual components (e.g., a display such as a plasma display panel (PDF), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location anchor force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 730, 732, 734, and/or memory of the processors) 710) and/or the storage unit 736 may store one or more sets of instructions 716 and data structures (e.g., software) embodying or utilized by any one or more of the methodologies or functions described herein. These instructions (e.g., the instructions 716), when executed by the processors) 710, cause various operations to implement the disclosed embodiments.

As used herein, the terms “machine-storage medium,” “device-storage medium” and “computer-storage medium” mean the same thing and may be used interchangeably. The terms refer to a single or multiple storage devices and/or media (e.g., a centralized or distributed database, and/or associated caches and servers) that store executable instructions 716 and/or data. The terms shall accordingly be taken to include, but not be limited to, solid-state memories, and optical and magnetic media, including memory internal or external to the processors 710. Specific examples of machine-storage media, computer-storage media, and/or device-storage media include non-volatile memory, including by way of example semiconductor memory devices, e.g., erasable programmable readonly memory (EPROM), electrically erasable programmable read-only memory (EEPROM), field-programmable gate array (FPGA) and flash memory devices, magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 780 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (BSPA), Worldwide Interoperability for Microwave Access (WiMAX), Long-Term Evolution (LTE) standard, others defined by various standard-setting organizations, other long-range protocols, or other data-transfer technology.

The instructions 716 may be transmitted or received over the network 780 using a transmission medium via a network interlace device (e.g., a network interface component included in the communication components 764) and utilizing any one of a number of well-known transfer protocols (e.g., HTTP). Similarly, the instructions 716 may be transmitted or received using a transmission medium via the coupling 772 (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 716 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising.
a computer-readable medium having instructions stored thereon, which, when executed by a processor, cause the system to:
obtain, at an offline analysis device, a query log from an online search engine device, the query log comprising a set of queries performed on a first database by a first version of a search engine ranking algorithm;
obtain, at the offline analysis device, a subset of a first set of search results returned at the online search engine device in response to the set of queries and interactivity data pertaining to interactions, via a graphical user interface, between users and results in the subset of the first set of search results;
replay, at the offline analysis device, queries in the query log, on a second database, using the first version of the search engine ranking algorithm, returning a second set of search results,
join the second set of search results with the interactivity data obtained from the online search engine device;
replay, at the offline analysis device, queries in the query log, on the second database, using a second version of the search engine ranking algorithm, returning a third set of search results;
evaluate the third set of search results against the second set of search results to determine if the second version of the search engine ranking algorithm demonstrates quality improvement over the first version of the search engine ranking algorithm; and
in response to the evaluating, cause the online search engine device to deploy the second version of the search engine ranking algorithm for new queries on the first database.

2. The system of claim 1, wherein the second database is a copied version of the first database.

3. The system of claim 1, wherein the second database contains an index portion of the first database.

4. The system of claim 3, wherein the index portion is a version of the index portion of the first database, but having more fine-grained shards to accelerate execution time of the replaying.

5. The system of claim 1, wherein the instructions further cause the system to train the second version of the search engine ranking algorithm by adding in one or more experimental features to the first version of the search engine ranking algorithm and training weights for features of the second version of the search engine ranking algorithm using this joined second set of search results and interactivity data obtained from the online search engine device.

6. The system of claim 5, wherein the training uses a linear model.

7. The system of claim 5, wherein the training uses a tree model.

8. A computerized method comprising:
obtaining, at an offline analysis device, a query log from an online search engine device, the query log comprising a set of queries performed on a first database by a first version of a search engine ranking algorithm;
obtaining, at the offline analysis device, a subset of a first set of search results returned at the online search engine device in response to the set of queries and interactivity data pertaining to interactions, via a graphical user interface, between users and results in the subset of the first set of search results;
replaying, at the offline analysis device, queries in the query log, on a second database, using the first version of the search engine ranking algorithm, returning a second set of search results;
joining the second set of search results with the interactivity data obtained from the online search engine device;
replaying, at the offline analysis device, queries in the query log, on the second database, using a second version of the search engine ranking algorithm, returning a third set of search results;
evaluating the third set of search results against the second set of search results to determine if the second version of the search engine ranking algorithm demonstrates quality improvement over the first version of the search engine ranking algorithm; and
in response to the evaluating, causing the online search engine device to deploy the second version of the search engine ranking algorithm for new queries on the first database.

9. The computerized method of claim 8, wherein the second database is a copied version of the first database.

10. The computerized method of claim 8, wherein the second database contains an index portion of the first database, the index portion identifying search results documents.

11. The computerized method of claim 10, wherein the index portion is a version of the index portion of the first database, but having more fine-grained shards to accelerate execution time of the replaying.

12. The computerized method of claim 8, further comprising training the second version of the search engine ranking algorithm by adding in one or more experimental features to the first version of the search engine ranking algorithm and training weights for features of the second version of the search engine ranking algorithm using this joined second set of search results and interactivity data obtained from the online search engine device.

13. The computerized method of claim 12, wherein the training uses a linear model.

14. The computerized method of claim 12, wherein the training uses a tree model.

15. A non-transitory machine-readable storage medium comprising instructions which, when implemented by one or more machines, cause the one or more machines to perform operations comprising:
obtaining, at an offline analysis device, a query log from an online search engine device, the query log comprising a set of queries performed on a first database by a first version of a search engine ranking algorithm;
obtaining, at the offline analysis device, a subset of a first set of search results returned at the online search engine device in response to the set of queries and interactivity data pertaining to interactions, via a graphical user interface, between users and results in the subset of the first set of search results;
replaying, at the offline analysis device, queries in the query log, on a second database, using the first version of the search engine ranking algorithm, returning a second set of search results;
joining the second set of search results with the interactivity data obtained from the online search engine device;
replaying, at the offline analysis device, queries in the query log, on the second database, using a second version of the search engine ranking algorithm, returning a third set of search results;
evaluating the third set of search results against the second set of search results to determine if the second version of the search engine ranking algorithm demonstrates quality improvement over the first version of the search engine ranking algorithm; and
in response to the evaluating, causing the online search engine device to deploy the second version of the search engine ranking algorithm for new queries on the first database.

16. The non-transitory machine-readable storage medium of claim 15, wherein the second database is a copied version of the first database.

17. The non-transitory machine-readable storage medium of claim 15, wherein the second database contains an index portion of the first database, the index portion identifying search results documents, the second database.

18. The non-transitory machine-readable storage medium of claim 17, wherein the index portion is a version of the index portion of the first database, but having more fine-grained shards to accelerate execution time of the replaying.

19. The non-transitory machine-readable storage medium of claim 15, wherein the operations further comprise training the second version of the search engine ranking algorithm by adding in one or more experimental features to the first version of the search engine ranking algorithm and training weights for features of the second version of the search engine ranking algorithm using this joined second set of search results arid interactivity data obtained from the online search engine device.

20. The non-transitory machine-readable storage medium of claim 19, wherein the training uses a linear model.
